(19) United States
(12) Patent Application Publication
(10) Pub. No.: US 2025/0237255 A1
(43) Pub. Date: Jul. 24, 2025

(54) Fastener

(71) Applicant: Illinois Tool Works Inc., Glenview, IL (US)

(72) Inventors: Zhilin LI, Shanghai (CN); Xiaojin LIU, Shanghai (CN); Leyao ZHANG, Shanghai (CN)

(21) Appl. No.: 19/027,240

(22) Filed: Jan. 17, 2025

(30) Foreign Application Priority Data
Jan. 19, 2024 (CN) 202410082250.8

(51) Int. Cl. F16B 21/02; F16B 21/08

(52) U.S. Cl. CPC F16B 21/02; F16B 21/086

(57) ABSTRACT

The present disclosure provides a fastener, including: a supporting disc, the supporting disc having a first side and a second side disposed opposite to each other; a connection portion connected to the first side of the supporting disc and extending in an axial direction of the supporting disc; and a sealing portion connected to a circumferential edge of the supporting disc, the sealing portion including a side wall and an extension portion, wherein the side wall extends from the circumferential edge of the supporting disc in a direction away from the connection portion, the extension portion is located on an outer side of the side wall and extends from a distal end of the side wall toward the supporting disc, and a receiving groove is formed between the extension portion and an outer surface of the side wall. The fastener in the present disclosure has a simple sealing structure.

### RELATED APPLICATIONS

The present application claims the benefit of Chinese Patent Application No. 202410082250.8, filed Jan. 19, 2024, titled “Fastener,” the contents of which are hereby incorporated by reference.

### TECHNICAL FIELD

The present disclosure relates to a fastener, and in particular to a fastener for use in a vehicle.

### BACKGROUND

Fasteners can be used for connecting multiple components together, for example, connecting interior trim parts, frames, panels and similar components of a vehicle. For connection, a first component is first connected to a fastener, and then the fastener with the first component connected thereto is mounted at a corresponding hole or groove on a second component. The first component and the second component are thus connected.

### SUMMARY

The present disclosure relates generally to a fastener, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastener according to the present disclosure.

FIG. 1B is a perspective view of the fastener in FIG. 1A from another perspective.

FIG. 1C is a side view of the fastener in FIG. 1B.

FIG. 1D is a side view of the fastener in FIG. 1C from another perspective.

FIG. 1E is a bottom view of the fastener in FIG. 1A.

FIG. 2A is a cross-sectional view of the fastener in FIG. 1E taken along line A-A.

FIG. 2B is a schematic view of the fastener in FIG. 1E taken along line B-B.

FIG. 3 is a perspective view of the fastener in FIG. 1A, a first component and a second component.

FIG. 4A is a perspective view of the first component in FIG. 3.

FIG. 4B is a perspective view of the first component in FIG. 4A from another perspective.

FIG. 5A is a cross-sectional view of the fastener in the first component in a pre-assembly position.

FIG. 5B is a cross-sectional view of the fastener in the first component leaving the pre-assembly position.

FIG. 6A is a perspective view of a fastener mounted into the first component and the second component.

FIG. 6B is a perspective view of the fastener when securely connecting the first component to the second component.

FIG. 6C is a cross-sectional view of FIG. 6B.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastener for connecting a first component to a second component, the fastener including: a supporting disc, the supporting disc having a first side and a second side disposed opposite to each other; a connection portion, the connection portion being connected to the first side of the supporting disc and extending in an axial direction of the supporting disc; and a sealing portion, the sealing portion being connected to a circumferential edge of the supporting disc, and the sealing portion including a side wall and an extension portion, wherein the side wall extends from the circumferential edge of the supporting disc in a direction away from the connection portion, the extension portion is located on an outer side of the side wall and extends from a distal end of the side wall toward the supporting disc, and a receiving groove is formed between the extension portion and an outer surface of the side wall.

In the fastener as described above, the fastener is integrally formed from a thermoplastic material, and the sealing portion extends continuously in a circumferential direction.

In the fastener as described above, the outer surface of the side wall of the sealing portion includes a first contact surface, the first contact surface extending obliquely away from a central axis of the supporting disc in a direction from a proximal end to the distal end of the side wall.

In the fastener as described above, an inner surface of the extension portion includes a second contact surface, the second contact surface extending obliquely away from a central axis of the supporting disc in a direction from the distal end of the side wall to the supporting disc.

In the fastener as described above, there is a spacing between a distal end of the extension portion and the second side of the supporting disc in the axial direction of the supporting disc.

In the fastener as described above, in the axial direction of the supporting disc, the height of the extension portion is not less than ⅓ of the height of the side wall.

In the fastener as described above, the extension portion has a smaller thickness than the side wall.

In the fastener as described above, the connection portion includes a locking portion, the locking portion including a pair of first side portions disposed opposite each other and a pair of second side portions disposed opposite each other, wherein a spacing between outer sides of the pair of first side portions is greater than a spacing between outer sides of the pair of second side portions, each of the pair of first side portions has an inclined surface facing the supporting disc, and the fastener is configured to be rotatable in the first component and the second component such that the inclined surfaces abut against a surface of the component to be connected, so as to clamp the first component and the second component between the supporting disc and the inclined surfaces.

In the fastener as described above, the connection portion further includes a pair of retention arms, the pair of retention arms being disposed on the outer sides of the pair of second side portions, proximal ends of the pair of retention arms being connected to the supporting disc, distal ends of the pair of retention arms being deflectable toward the locking portion, and the pair of retention arms including, on their outer sides, first recesses and limiting sections arranged in the axial direction of the supporting disc, and the fastener is capable of retaining connection fitting portions of the first component in the first recesses, and moving relative to the first component when an external force is applied to the connection portion such that the connection fitting portions of the first component enter the limiting sections.

In the fastener as described above, the fastener is configured such that the fastener is insertable into an opening of the first component in a first direction, and when the fastener retains the connection fitting portions of the first component in the first recesses, a distal end of the connection portion extends beyond the opening of the first component in the first direction, and the connection portion reaches a pre-assembly position relative to the first component.

In the fastener as described above, when an external force is applied to the connection portion, the connection portion leaves the pre-assembly position relative to the first component, and the connection fitting portions of the first component are capable of entering the limiting sections, such that the distal end of the connection portion does not extend beyond the opening of the first component in the first direction, and after the external force applied to the connection portion is removed, the connection portion is capable of returning to the pre-assembly position, the limiting sections include second recesses.

In the fastener as described above, the fastener further includes an operating portion, wherein the operating portion is connected to the second side of the supporting disc and surrounded by the sealing portion, and the operating portion has an outer contour and/or a recess shaped for anti-rotation, thus enabling cooperation with a screwing tool.

The fastener in the present disclosure includes a sealing portion which enables a sealing connection between components to be connected. The fastener is an integrally formed part, and the sealing portion thereof does not require a secondary forming process to fabricate.

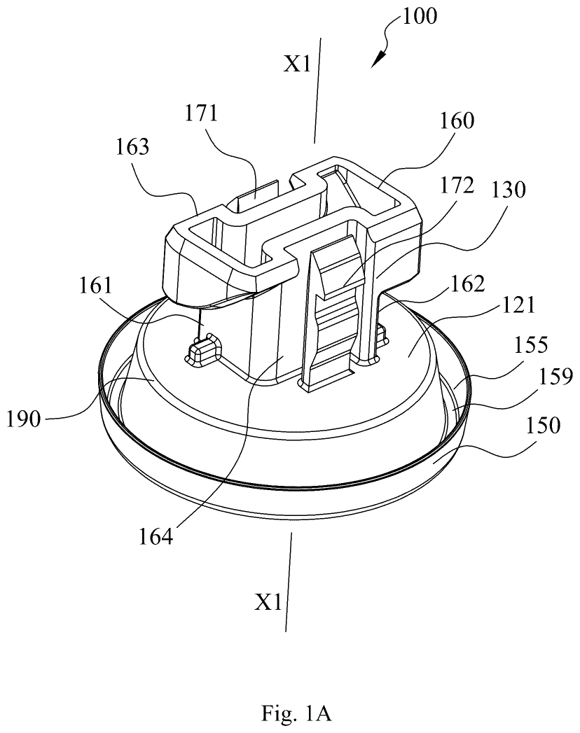

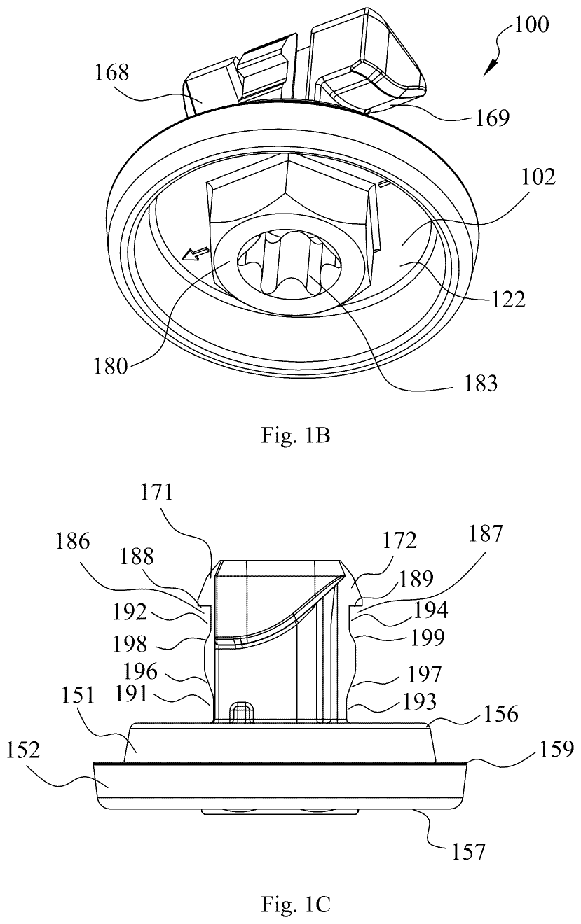

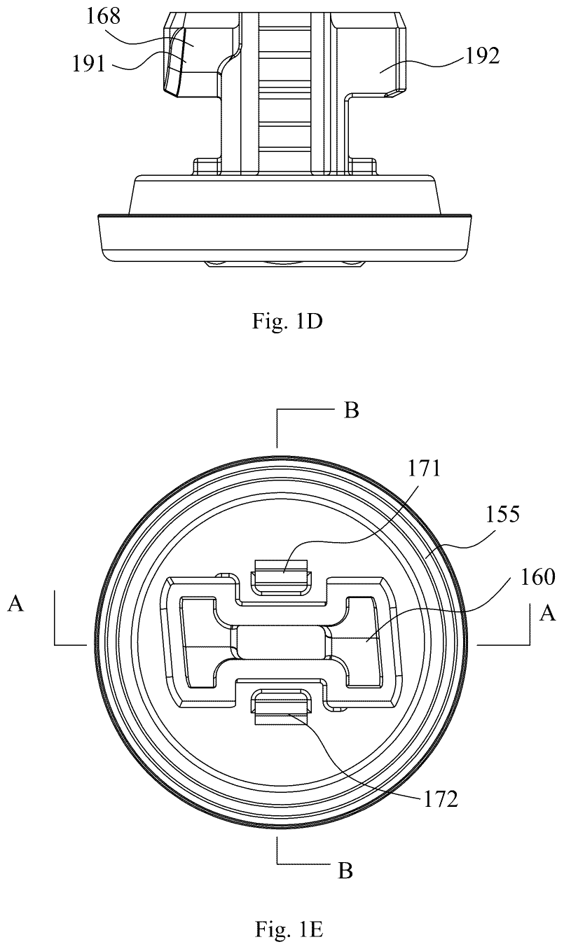

FIG. 1A is a perspective view of a fastener according to the present disclosure, FIG. 1B is a perspective view of the fastener in FIG. 1A from another perspective, FIG. 1C is a side view of the fastener in FIG. 1B, FIG. 1D is a side view of the fastener in FIG. 1C from another perspective, specifically, the view of the fastener in FIG. 1D being a view of the fastener in FIG. 1C rotated by 90° in an axial direction, and FIG. 1E is a bottom view of the fastener in FIG. 1A.

The fastener in FIGS. 1A-1E is configured to connect two components, for example, to connect an interior trim panel of a vehicle to sheet metal. As shown in FIGS. 1A-1E, the fastener 100 includes a supporting disc 102, a connection portion 130, a sealing portion 150, and an operating portion. The supporting disc 102 is substantially in the shape of a circular plate and has a central axis X1. In an axial direction of the supporting disc 102, the supporting disc 102 has a first side 121 and a second side 122 disposed opposite to each other. A surface on the first side 121 and a surface on the second side 122 both extend in a radial direction of the supporting disc 102. The connection portion 130 is connected to the middle of the first side 121 of the supporting disc 102 and extends in the axial direction of the supporting disc 102. The sealing portion 150 is connected to a circumferential edge 190 of the supporting disc 102 and extends in a direction away from the connection portion 130. The operating portion 180 is connected to the second side 122 of the supporting disc 102 and configured to cooperate with a screwing tool to rotate the fastener 100.

When connecting two components by using the fastener in FIG. 1A, the fastener 100 is pre-mounted to the first component, and the fastener with the first component connected thereto is then mounted into the second component, so that the fastener 100 connects the first component to the second component. When the fastener 100 connects the first component to the second component, the sealing portion 150 of the fastener 100 fits with the first component at a corresponding position, thereby forming a sealing between the fastener 100 and the first component.

As shown in FIGS. 1A-1E, the sealing portion 150 includes a side wall 151 and an extension portion 152. A proximal end 156 of the side wall 151 is connected to a peripheral edge of the supporting disc 102 and outwardly extends obliquely away from the connection portion 130 of the supporting disc 102, that is, extending away from the central axis X1 along the axial direction of the supporting disc 102. The extension portion 152 is connected to a distal end 157 of the side wall 151 and outwardly extends obliquely toward the supporting disc 102, that is, extending away from the central axis X1 along the axial direction of the supporting disc 102. In the axial direction of the supporting disc, the height of the extension portion 152 does not exceed that of the supporting disc 102, that is, there is a spacing between a distal end of the extension portion 152 and the supporting disc 102, and the height of the extension portion 152 is not less than ⅓ of the height of the side wall 151. The thickness of the extension portion 152 is less than the thickness of the side wall 151, and the thickness of the distal end of the extension portion 152 is less than the thickness of a proximal end of the extension portion 152. A receiving groove 155 is formed between the extension portion 152 and the side wall 151, and an opening 159 of the receiving groove 155 faces the plane where the supporting disc 102 lies in. The receiving groove 155 is configured to accommodate a corresponding portion of the first component. The receiving groove 155 gradually increases in thickness in a direction from the connection between the extension portion 152 and the side wall 151 to the opening 159, to facilitate guiding the corresponding portion of the first component into the receiving groove 155. The connection between the extension portion 152 and the side wall 151 has a smooth transition.

As shown in FIGS. 1A-1E, the connection portion 130 extends in the axial direction from the middle of the first side 121 of the supporting disc 102. The connection portion 130 includes a locking portion 160 and a pair of elastic arms 171 and 172. The locking portion includes a pair of first side portions 161 and 162 disposed opposite each other, and a pair of second side portions 163 and 164 disposed opposite each other. The first side portions 161 and 162 are connected at one end to the first side 121 of the supporting disc 102, and are provided at the other end with a pair of protrusions 191 and 192 protruding outwardly from outer surfaces of the first side portions 161 and 162. The protrusions 191 and 192 have a pair of inclined surfaces 168 and 169, respectively, facing the supporting disc 102. The inclined surface 168 extends obliquely away from the supporting disc 102 in a direction from the second side portion 163 to the second side portion 164, and the inclined surface 169 extends obliquely toward the supporting disc 102 in the direction from the second side portion 163 to the second side portion 164. That is, the inclined surfaces 168 and 169 are inclined in opposite directions in the direction from the second side portion 163 to the second side portion 164. The inclined surfaces 168 and 169 cooperate with the supporting disc 102 to clamp the first component and the second component to be connected. Each of the inclined surfaces 168 and 169 has a spacing from the first side 121 of the supporting disc 102, the spacing being related to the thicknesses of the first component and the second component to be connected.

The connection portion 130 further includes a pair of retention arms 171 and 172. The retention arms 171 and 172 are disposed on outer sides of the pair of second side portions 163 and 164 and spaced apart from the second side portions 163 and 164. Proximal ends of the retention arms 171 and 172 are connected to the first side 121 of the supporting disc 102, and distal ends thereof can be deflected toward the locking portion 160. Outer sides of the retention arms 171 and 172 include first recesses 191 and 193 arranged along the axial direction of the supporting disc 102, and limiting sections 186 and 187. In an embodiment of the present disclosure, the limiting sections 186 and 187 include second recesses 192, 194. The first recesses 191 and 193 are closer to the supporting disc 102 than the second recesses 192 and 194. The first recesses 191 and 193 include upper guide surfaces 196 and 197. The upper guide surfaces 196 and 197 are located at the end of the first recesses 191 and 193 away from the supporting disc 102, and the upper guide surfaces 196 and 197 extend obliquely away from each other in a direction away from the supporting disc 102. The second recesses 192 and 194 include lower guide surfaces 198 and 199, and limiting surfaces 188 and 189. The lower guide surfaces 198 and 199 are located at the ends of the second recesses 192 and 194 close to the supporting disc 102, and the limiting surfaces 188 and 189 are located at the ends thereof away from the supporting disc 102. The lower guide surfaces 198 and 199 extend obliquely toward each other in the direction away from the supporting disc 102, and the limiting surfaces 188 and 189 extend substantially parallel to the supporting disc 102.

After the fastener 100 is mounted into the first component, the fastener 100 can move relative to the first component. The first recesses 191 and 193 are configured to pre-mount the fastener in the first component such that fitting portions of the first component are retained in the first recesses 191 and 193. During the mounting of the fastener, if the connection portion 130 is subjected to a corresponding external force, the fastener can be moved relative to the first component such that the fitting portions of the first component enter the second recesses 192 and 194. The included angles between each of the upper guide surfaces 196, 197, the lower guide surfaces 198, 199 and the extension direction of the supporting disc 102 are greater than 45°. The upper guide surfaces 196 and 197 and the lower guide surfaces 198 and 199 are configured to guide the corresponding fitting portions of the first component to move between the first recesses 191 and 193 and the second recesses 192 and 194. The limiting surfaces 188 and 189 are configured to prevent the fastener 100 from leaving the first component.

In another embodiment of the present disclosure, the limiting sections 186 and 187 are smooth inclined surfaces and include no recesses.

The fastener 100 further includes an operating portion 180. The operating portion 180 is connected to the second side 122 of the supporting disc 102 and surrounded by the sealing portion 150. The operating portion 180 has an anti-rotation shaped outer contour. In an embodiment of the present disclosure, the operating portion 180 has a hexagonal outer contour. The operating portion 180 further includes a recess 183 having an anti-rotation shaped outer contour. In an embodiment of the present disclosure, the recess 183 is torx shaped. The operating portion 180 and the recess are shaped to facilitate the cooperation with a screwing tool (e.g., a wrench, a screwdriver) to rotate the fastener 100.

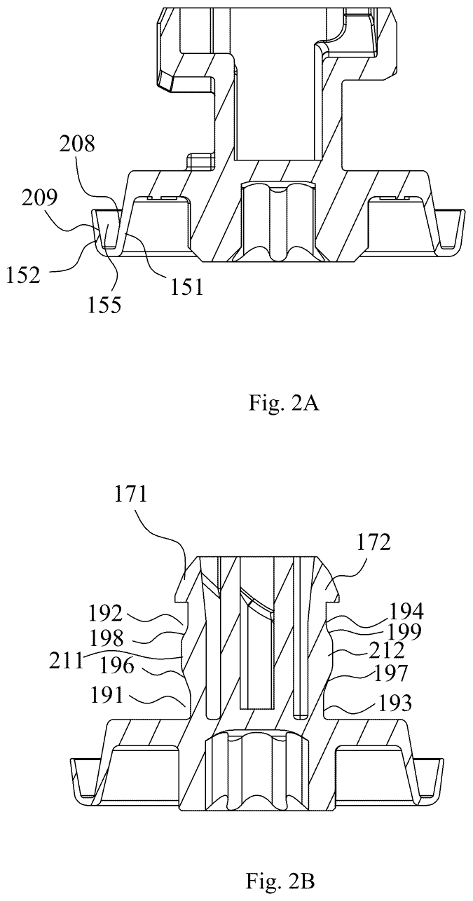

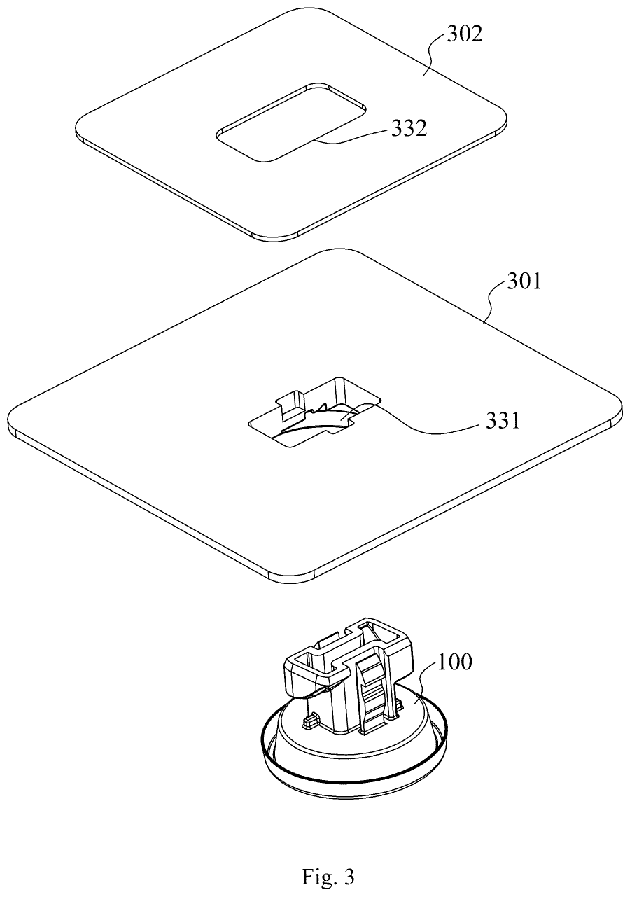

FIG. 2A is a cross-sectional view of the fastener in FIG. 1E taken along line A-A, and FIG. 2B is a schematic view of the fastener in FIG. 1E taken along line B-B.

As shown in FIGS. 2A and 2B, the receiving groove 155 is formed between the side wall 151 and the extension portion 152, and the receiving groove 155 gradually increases in thickness from the bottom opening to form a flared shape, to facilitate the guiding of the corresponding portion of the first component into the receiving groove 155. The receiving groove 155 has a first contact surface 208 and a second contact surface 209. The first contact surface 208 is formed by the side wall 151, and the first contact surface 208 is arranged toward the extension portion 152 and extends obliquely away from the second side 122 of the supporting disc 102 and away from the central axis of the supporting disc. The second contact surface 209 is formed by the extension portion 152, and the second contact surface 209 is arranged toward the side wall 151 and extends obliquely toward the second side 122 of the supporting disc 102 and away from the central axis of the supporting disc. The first contact surface 208 and the second contact surface 209 are configured to fit with corresponding portions of the first component, thereby forming a sealing between the fastener 100 and the first component.

The first retention arms 171 and 172 are both spaced apart from the locking portion 160 so as to be able to deflect toward the locking portion 160. The first retention arm 171 has a transition portion 211 between the first recess 191 and the second recess 192 thereof, and the second retention arm 172 has a transition portion 212 between the first recess 193 and the second recess 194 thereof. The transition portion 211 forms a smooth transition with the upper guide surface 196 and the lower guide surface 198, and the transition portion 212 forms a smooth transition with the upper guide surface 197 and the lower guide surface 197, thereby facilitate the sliding of the fastener 100 relative to the first component between the first recesses 191, 193 and the second recesses 192, 194.

FIG. 3 is a perspective view of the fastener in FIG. 1A, the first component and the second component. As shown in FIG. 3, the fastener 100 is configured to connect the first component 301 to the second component 302. The first component 301 has a substantially rectangular first opening 331, and the second component 302 has a substantially rectangular second opening 332. When connecting the first component 301 to the second component 302, the fastener 100 is first inserted into the first opening 331 of the first component 301 such that the fastener 100 is pre-mounted to the first component 301, the fastener 100 with the first component 301 connected thereto is then inserted into the second opening 332 of the second component 302, and the fastener 100 is rotated such that the inclined surfaces 168 and 169 of the locking portion 160 abut against the second component 302. In this way, the fastener 100 connects the first component 301 to the second component 302.

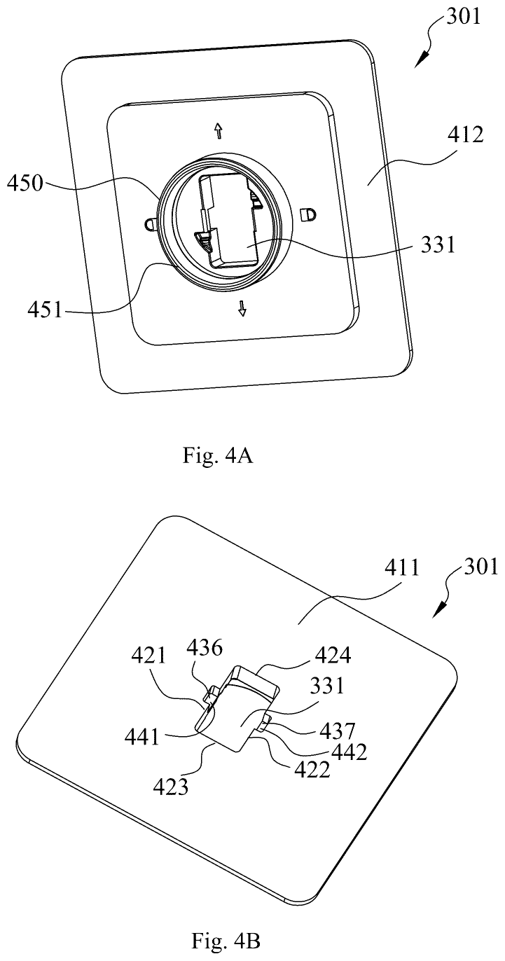

FIG. 4A is a perspective view of the first component in FIG. 3, and FIG. 4B is a perspective view of the first component in FIG. 4A from another perspective. As shown in FIGS. 4A and 4B, the first component 301 is substantially in the shape of a plate and has a first side 411 and a second side 412 disposed opposite to each other. The first opening 311 is substantially rectangular and penetrates through the first side 411 and the second side 412. The first opening 311 has a pair of length sides 421 and 422 and a pair of width sides 423 and 424. When the fastener 100 is inserted into the first opening 311, the length sides 421 and 422 correspond to the second side portions 163 and 164 of the locking portion 160, and the width sides 423 and 424 correspond to the first side portions 161 and 162 of the locking portion 160.

The first component 301 further includes a pair of accommodating portions 436 and 437. The pair of accommodating portions 436 and 437 are recessed from the first side 411 toward the second side 412 and are spaced apart from the second side. The pair of accommodating portions 436 and 437 are located at the length sides 421 and 422, respectively, and are in communication with the first opening 331. The pair of accommodating portions 436 and 437 are used to accommodate the pair of retention arms 171 and 172 of the fastener 100. Connection fitting portions 441 and 442 are formed between the bottoms of the accommodating portions 436 and 437 and the second side 412. The connection fitting portions 441 and 442 can fit with the first recesses 191 and 193 and the second recesses 192 and 194 of the retention arms 171 and 172.

The first component 301 further includes a sealing fitting portion 450. The sealing fitting portion 450 has an annular wall 451. A first end of the annular wall 451 is connected to the second side 412 of the first component 301 and is arranged around the first opening 331. The diameter of the annular wall 451 corresponds to the dimensions of the sealing portion 150 of the fastener 100 such that a second end of the annular wall 451 can enter the receiving groove 155 of the sealing portion 150 and be in contact with the first contact surface 208 and/or the second contact surface 209, thereby forming a sealing between the sealing fitting portion 450 and the scaling portion 150.

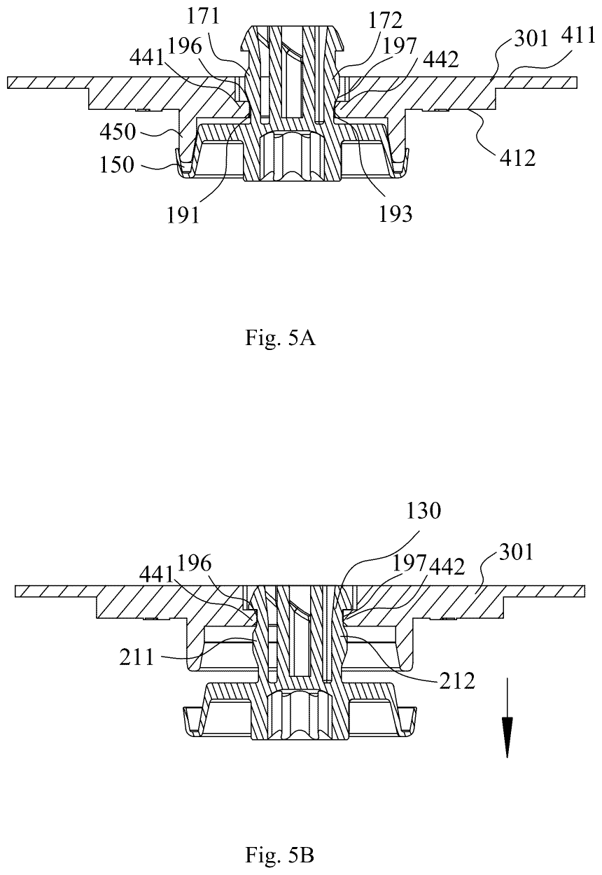

FIG. 5A is a cross-sectional view of the fastener in the first component in a pre-assembly position, and FIG. 5B is a cross-sectional view of the fastener in the first component leaving the pre-assembly position. As shown in FIG. 5A, when the fastener 100 is inserted into the first opening 331 from the second side 412 of the first component and reaches the pre-assembly position, the sealing fitting portion 450 enters the receiving groove 155 of the fastener 100. The connection fitting portions 441 and 442 of the first component 301 enter the first recesses 191 and 193 and are retained in the first recesses 191 and 193. In this case, the connection fitting portions 441 and 442 are blocked by the upper guide surfaces 196 and 197 of the first recesses 191 and 192, so that the fastener 100 is less likely to be escaped from the first component, and the fastener 100 reaches the pre-assembly position relative to the first component 301. In the pre-assembly position, the connection portion 130 of the fastener 100 extends beyond the first side 411 of the first component 301.

During the connection of the fastener 100 with the first component 301 connected thereto to the second component 302, the connection portion 130 of the fastener 100 may be not yet aligned with the second opening 332 of the second component 302. In this case, if a force is applied to the first component 301 or the second component 302 to bring them closer to each other, the fastener 100 will move relative to the first component 301. As shown in FIG. 5B, when the connection portion 130 is subjected to an external downward force as indicated by the arrow, the retention arms 171 and 172 are pressed by the connection fitting portions 441 and 442 and deflected inwardly, such that the transition portions 211 and 212 of the connection portion 130 can pass over the connection fitting portions 441 and 442, and the connection fitting portions 441 and 442 can enter the second recesses 193 and 194. In this case, the fastener 100 has left the pre-assembly position relative to the first component 301. In the position shown in FIG. 5B, the connection portion 130 is flush with the first side 411 of the first component 301, without affecting the approach of the first component 301 to the second component 302, but in the position shown in FIG. 5B, the fastener 100 is in an unstable position relative to the first component 301. When the external force is removed, the retention arms 171 and 172 have a tendency to deflect outwardly so that the fastener 100 can slide upwardly relative to the first component 301, to return the fastener 100 to the pre-assembly position shown in FIG. 5A.

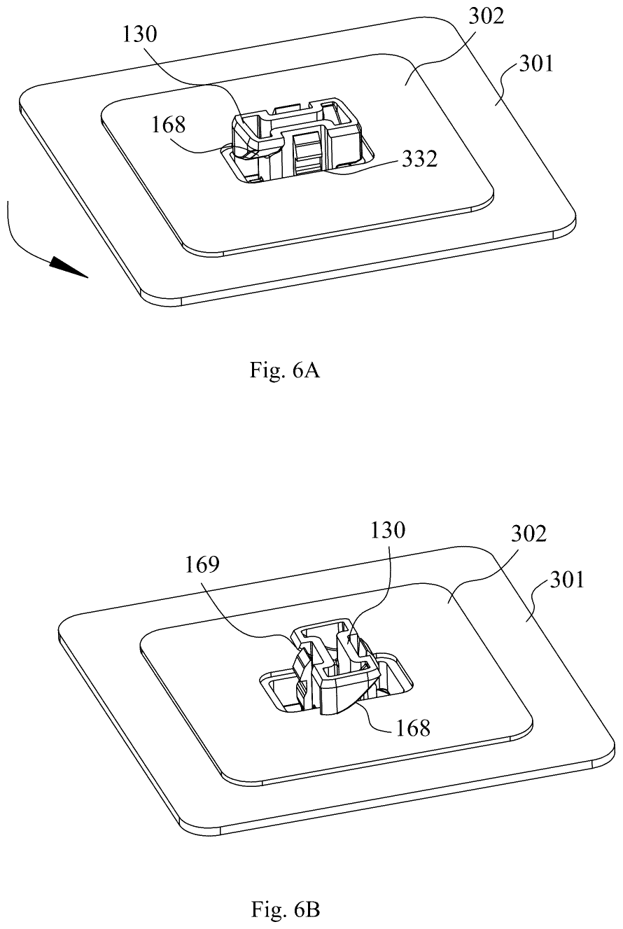

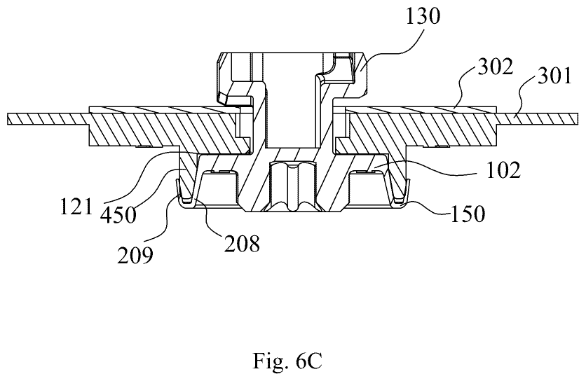

FIG. 6A is a perspective view of the fastener mounted into the first component and the second component, FIG. 6B is a perspective view of the fastener when securely connecting the first component to the second component, and FIG. 6C is a cross-sectional view of FIG. 6B.

As shown in FIG. 6A, when connecting the first component 301 to the second component 302, the fastener 100 is pre-mounted in the first component 301, and the connection portion 130 of the fastener 100 is aligned with the second opening 332 of the second component 302, such that when the connection portion 130 passes through the second opening 332, the first component 301 can abut against the second component 302. In this case, the tops of the inclined surfaces 168 and 169 are higher than the first component 301. The fastener 100 then rotates in a clockwise direction as shown in FIG. 6A, to reach the position as shown in FIG. 6B. In this case, the first component 301 is securely connected to the second component 302.

As shown in FIGS. 6B and 6C, the bottoms of the inclined surfaces 168 and 169 of the connection portion 130 abut against a surface of the second component 302, the first component 301 abuts against the first side 121 of the supporting disc 102, and the first component 301 and the second component 302 are thus retained between the inclined surfaces 168 and 169 and the supporting disc 102. Rotating the fastener 100 can change contact points on the inclined surfaces 168 and 169 to adjust pressing force between the first component 301 and the second component 302, so that the first component 301 is securely connected to the second component 302. As the fastener 100 rotates in the first component 301 and the second component 302, the sealing fitting portion 450 enters the receiving groove of the sealing portion 150 and presses the side wall 151 and the extension portion 152, causing the side wall 151 and the extension portion 152 to deform slightly, so that the sealing fitting portion 450 is in contact with at least one of the first contact surface 208 and the second contact surface 209 and forms a sealing therewith, and fluids on two sides of first component 301 and the second component 302 cannot communicate with each other through the first opening 331 and the second opening 332. In an embodiment of the present disclosure, the first component is a door module of the vehicle and the second component is door sheet metal of the vehicle.

The fastener 100 in the present disclosure is an integrally formed part, and the sealing portion thereof does not require secondary processing. The manufacturing process is simple.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A fastener for connecting a first component to a second component, the fastener comprising:
a supporting disc (102), the supporting disc (102) having a first side (121) and a second side (122) disposed opposite to each other;
a connection portion (130), the connection portion (130) being connected to the first side (121) of the supporting disc (102) and extending in an axial direction of the supporting disc (102); and
a sealing portion (150), the sealing portion (150) being connected to a circumferential edge of the supporting disc (102), and the sealing portion (150) comprising a side wall (151) and an extension portion (152),
wherein the side wall (151) extends from the circumferential edge of the supporting disc (102) in a direction away from the connection portion (130), the extension portion (152) is located on an outer side of the side wall (151) and extends from a distal end of the side wall (151) toward the supporting disc (102), and a receiving groove (155) is formed between the extension portion (152) and an outer surface of the side wall (151).

2. The fastener of claim 1, wherein the fastener is integrally formed from a thermoplastic material, and the sealing portion (150) extends continuously in a circumferential direction.

3. The fastener of claim 1, wherein the outer surface of the side wall (151) of the sealing portion (150) comprises a first contact surface (208), the first contact surface (208) extending obliquely away from a central axis of the supporting disc (102) in a direction from a proximal end to the distal end of the side wall (151).

4. The fastener of claim 1, wherein an inner surface of the extension portion (152) comprises a second contact surface (209), the second contact surface (209) extending obliquely away from a central axis of the supporting disc (102) in a direction from the distal end of the side wall (151) to the supporting disc (102).

5. The fastener of claim 1, wherein there is a spacing between a distal end of the extension portion (152) and the second side (122) of the supporting disc (102) in the axial direction of the supporting disc (102).

6. The fastener of claim 1, wherein in the axial direction of the supporting disc (102), a height of the extension portion (152) is not less than ⅓ of a height of the side wall (151).

7. The fastener of claim 1, wherein the extension portion (152) has a smaller thickness than the side wall (151).

8. The fastener of claim 1, wherein the connection portion (130) comprises a locking portion (160), the locking portion (160) comprising a pair of first side portions (161, 162) disposed opposite each other and a pair of second side portions (163, 164) disposed opposite each other,
wherein a spacing between outer sides of the pair of first side portions (161, 162) is greater than a spacing between outer sides of the pair of second side portions (163, 164), each of the pair of first side portions (161, 162) has a inclined surface (168, 169) facing the supporting disc (102), and the fastener is configured to be rotatable in the first component and the second component such that the inclined surfaces (168, 169) abut against a surface of the component to be connected, so as to clamp the first component and the second component between the supporting disc (102) and the inclined surfaces (168, 169).

9. The fastener of claim 8,
wherein the connection portion (130) further comprises a pair of retention arms (171, 172), the pair of retention arms (171, 172) being disposed on the outer sides of the pair of second side portions (163, 164), proximal ends of the pair of retention arms (171, 172) being connected to the supporting disc (102), distal ends of the pair of retention arms (171, 172) being deflectable toward the locking portion (160), and the pair of retention arms (171, 172) comprising, on their outer sides, first recesses (191, 193) and limiting sections arranged in the axial direction of the supporting disc (102), and
wherein the fastener is capable of retaining connection fitting portions of the first component in the first recesses (191, 193), and moving relative to the first component when an external force is applied to the connection portion (130) such that the connection fitting portions of the first component enter the limiting sections.

10. The fastener of claim 9, wherein the fastener is configured such that the fastener is insertable into an opening of the first component in a first direction, and when the fastener retains the connection fitting portions of the first component in the first recesses (191, 193), a distal end of the connection portion (130) extends beyond the opening of the first component in the first direction, and the connection portion (130) reaches a pre-assembly position relative to the first component.

11. The fastener of claim 10, wherein when an external force is applied to the connection portion (130), the connection portion (130) leaves the pre-assembly position relative to the first component, and the connection fitting portions of the first component are capable of entering the limiting sections, such that the distal end of the connection portion (130) does not extend beyond the opening of the first component in the first direction, and after the external force applied to the connection portion (130) is removed, the connection portion (130) is capable of returning to the pre-assembly position, the limiting sections include second recesses.

12. The fastener of claim 1, further comprising an operating portion (180),
wherein the operating portion (180) is connected to the second side (122) of the supporting disc (102) and surrounded by the sealing portion (150), and the operating portion (180) has an outer contour and/or a recess shaped for anti-rotation, thus enabling cooperation with a screwing tool.
